(19) United States
(12) Patent Application Publication
(10) Pub. No.: US 2023/0281425 A1
(43) Pub. Date: Sep. 7, 2023

(54) Method and Apparatus for Determining a Robustness of a Data-Based Sensor Model

(71) Applicant: Robert Bosch GmbH, Stuttgart (DE)

(72) Inventors: Matthias Woehrle, Bietigheim-Bissingen (DE); Frank Schmidt, Leonberg (DE); Konrad Groh, Stuttgart (DE)

(21) Appl. No.: 18/175,693

(22) Filed: Feb. 28, 2023

(30) Foreign Application Priority Data
Mar. 4, 2022 (DE) 10 2022 202 218.1

(51) Int. Cl. G06N 3/04

(52) U.S. Cl. CPC G06N 3/04

(57) ABSTRACT

A computer-implemented method determines a degree of robustness for a robustness of a provided, trained, data-based sensor model for evaluating an input dataset having at least one signal time series in order to determine a model output representing a change-point time. The method includes providing a plurality of unlabeled validation input datasets to the sensor model, and determining a plurality of robust validation input datasets of the plurality of unlabeled validation input datasets that satisfy a first robustness criterion and/or a second robustness criterion. The method further includes determining a proportion of the plurality of robust validation input datasets out of the plurality of unlabeled validation input datasets in order to obtain the degree of robustness.

This application claims priority under 35 U.S.C. § 119 to patent application no. DE 10 2022 202 218.1, filed on Mar. 4, 2022 in Germany, the disclosure of which is incorporated herein by reference in its entirety.

The disclosure relates to sensor models for evaluating time series data and determining a change-point time. In particular, the disclosure relates to methods for evaluating a robustness of a trained, data-based sensor model.

### BACKGROUND

Data-based models are used in a variety of ways to evaluate data in the area of controlling, regulating, and monitoring technical systems. One application is to examine time series data after a so-called change-point time, i.e., a time at which a significant change in system behavior occurs. For this purpose, data-based classification models are often used, which obtain input-side time series data of an input variable and map it onto an output vector in which the index value of the element with the highest and lowest values, respectively, is indicative of the change-point time.

However, data-based models have the disadvantage that they have no comprehensible behavior and thus cannot readily offer a conclusion about the quality and robustness of the data-based model. Particularly when used in safety-sensitive engineering systems, a quantified indication of robustness in terms of interferences is helpful in order to certify model performance for a particular application.

### SUMMARY

According to the disclosure, a method for evaluating a robustness of a data-based system model and a corresponding apparatus are disclosed herein.

According to a first aspect, a computer-implemented method for determining a degree of robustness for a robustness of a provided, trained, data-based sensor model for evaluating an input dataset having at least one signal time series in order to determine a model output representing a change-point time, having the following steps (i) providing in particular unlabeled validation input datasets to the sensor model, (ii) determining robust validation input datasets that satisfy a first and/or second robustness criterion, and (iii) determining a proportion of robust validation input datasets out of the total number of validation input datasets in order to obtain the degree of robustness.

As described earlier, the above method relates to a data-based sensor model for evaluating a sensor signal time series e.g. of a conventional sensor that is continuously being sampled in sensing steps. Such a sensor can be, for example, a pressure sensor, a mass flow sensor, an acceleration sensor, a vibration sensor, a radiation sensor, or the like. In order to monitor a change over time, such sensors are usually sampled continuously over time at a predetermined sampling frequency, and thus a sensor signal time series is provided in an analog or digitized manner. Such a signal time series can be evaluated in a variety of ways.

In order to monitor system states, it is often necessary to detect a time point at which a significant state change occurs in the technical system to be surveyed. Such a time point is called a change-point time.

A group of data-based sensor models have proven themselves in particular for evaluating a sensor signal time series to determine a change-point time. To this end, the sensor signal time series is sampled, and a time period for the sensor signal is selected via an evaluation time window. The period for the sensor signal time series detected within the evaluation time window is fed to the sensor model as the evaluation signal time series in the form of an input vector. Said model can be configured as a data-based classification model so that, as a function of the input vector, an output vector is output that is configured as a classification vector. This classification vector typically features dimensionality, with a number of elements each being associated with a class and each being associated with a given point in time within the evaluation window of the sensor signal time series. The argmax of the classification vector corresponds to the classification to be determined, i.e., the index value of the relevant element in the output vector corresponds to a certain previously specified time within the evaluation window. The sensor model can thus be designed to indicate the change-point time as a classification vector, wherein the change-point time is indicated as argmax of the classification vector.

By using the sensor model as a classification model, an evaluation signal time series is classified and, according to a trained sensor model, a change-point time in the sensor signal time series is thereby determined within the selected evaluation signal window. The value for the classification vector element, i.e. typically the element having the highest value, then has an index value that determines the time in the sensor signal time series corresponding to the change-point time.

Training such a data-based sensor model is typically performed using specified training datasets in an inherently known manner. The training datasets assign an input data vector in which at least one signal time series is represented, which is obtainable by sampling a sensor signal within a specified evaluation signal time window. A model evaluation is performed by providing a corresponding input dataset in order to obtain a classification vector by forward calculation of the sensor model.

One problem with data-based sensor models based solely on neural networks is that the behavior of the sensor model is difficult to predict, and an output from the sensor model cannot be guaranteed within a certain range of values. As a result, use in safety-sensitive systems, e.g. systems with driving relevance to motor vehicles and the like, is generally not permitted.

In addition, one difficulty is in evaluating the sensor model for its robustness against interferences. In particular, when evaluating sensor signals, interference variables can be included in the respective signal time series. However, these can only have a limited impact on the model evaluation of the data-based classification model.

Common methods therefore provide that the robustness of a trained, data-based sensor model be made available for evaluating at least one signal time series to determine a change-point time, wherein, for a specified quantity of validation input datasets, it is checked whether they remain within a specified maximum deviation. The validation input datasets correspond to a subset of the available training data that is not used for training the data-based sensor model. For example, a robustness can be indicated as a proportion of the validation input datasets whose label deviates from the model prediction by more than a specified error deviation threshold (with specified distance metric). Naturally, only the individual validation input datasets are evaluated point-by-point, and not their local environments.

However, in real-world application, there are often unlabeled datasets, i.e. datasets having at least one signal time series that cannot be assigned a change-point time. Nevertheless, the signal time series corresponds to the result of a particular mode of operation of the technical system and thus contains information about the nature and characteristics of the at least one signal time series.

The above method therefore provides for checking the robustness with a specified amount of, in particular, unlabeled validation input datasets. The validation input datasets need not be labeled, as they are not needed for the method described herein. For example, a degree of robustness can be determined as a proportion of validation input datasets labeled as non-robust out of the total number of validation input datasets.

This allows, for example, a continuous control of a sensor model used in real-world operation with respect to its robustness for the at least one signal time series provided by the technical system. The evaluation is carried out by determining a shift consistency. In particular, the validation input datasets are reviewed for their robustness based on a first robustness criterion and a second robustness criterion, respectively.

Thus, it can be provided that the first robustness criterion indicates that a validation input dataset is robust when a distance between a model output of the sensor model for the relevant validation input dataset and a model output of the sensor model for a modified validation input dataset falls below a first threshold value specified by a first threshold, wherein the modified validation input dataset corresponds to a temporal shift of the signal time series in the input dataset through an element-wise shift.

Thus, the above method provides that the trained, data-based sensor model with the validation input datasets is evaluated by checking for each validation input dataset whether a distance (corresponding to a specified distance metric) between the model outputs from the model evaluation for two signal time series offset from one another by a predetermined number of digits (left shift or right shift of the elements of the respective vector to be evaluated) in the relevant validation input dataset is less than a specified threshold value, which takes into account the temporal shift of the signal time series in the relevant validation input dataset. If not, the validation input dataset is non-robust.

The second robustness criterion can indicate that a validation input dataset is robust when a maximum distance between a minimum threshold value or maximum threshold value of a model output of the sensor model for the relevant validation input data dataset and a minimum threshold value or maximum threshold value of a model output of the sensor model for a modified validation input dataset falls below a second threshold value specified by a second threshold, wherein the modified validation input dataset corresponds to a temporal shift of the signal time series in the input dataset through an element-wise shift, wherein the minimum or maximum threshold value result from a distribution of model outputs from a specified epsilon environment of the validation input dataset and the modified validation input dataset, in particular by considering from the epsilon environment of the validation input dataset or the modified validation input. This can be performed using a mathematical model that overestimates a range around a data point. Here, the range around the data point is determined by a specified distance metric and a specified epsilon. Then, using the mathematical model, it is determined whether the classification can be changed or how large it is in this range.

Further, as the second robustness criterion, it is thus checked whether the maximum distance between the robust bodies of the model evaluations of a validation input dataset and a corresponding modified validation input dataset exceeds the specified second threshold value. If this is the case, the validation input dataset is non-robust.

The first threshold value and the second threshold value, respectively, can consider or depend on the temporal shift of the signal time series of the validation input dataset for creating the modified validation input dataset.

The trained sensor model can be configured in the form of a deep neural network comprising multiple neuron layers with neurons that are calibrated using model parameters. The first robustness criterion can indicate that a validation input dataset is robust when a distance between the model output of a first modified sensor model for the relevant validation input dataset, whose at least one signal time series is enlarged by a predetermined number of elements, and the model output of a second modified sensor model for the relevant validation input dataset, whose at least one signal time series is enlarged by the predetermined number of elements, falls below a first threshold value specified by a first threshold, wherein the first and second modified sensor models are formed by adding a number of additional neurons to the input neuron layer, wherein the model parameters of the neurons in the input neuron layer for the first and second modified sensor models are shifted in different ways in the increased number of neurons of the respective input neuron layer.

The second robustness criterion can alternatively indicate that a validation input dataset is robust when a maximum distance between a minimum threshold value or a maximum threshold value of a model output of a first modified sensor model for the respective validation input dataset, whose at least one signal time series is enlarged by a predetermined number of elements, and a minimum threshold value or a maximum threshold value of a model output of a second sensor model for the respective validation input dataset, whose at least one signal time series is enlarged by a predetermined number of elements, falls below a second threshold value specified by a second threshold, wherein the first and second modified sensor models are formed by adding a number of additional neurons to an input neuron layer, wherein the model parameters of the neurons in the input neuron layer for the first and second modified sensor models are adjusted in different ways to the increased number of values of the validation input datasets.

The trained sensor model can be designed in the form of a deep neural network comprising multiple neuron layers with neurons that are calibrated using model parameters, wherein the second robustness criterion indicates that a validation input dataset is robust when a maximum distance between a minimum threshold value or maximum threshold value of a model output of a first model evaluation for the relevant validation input dataset and a minimum threshold value or the maximum threshold value of a second model evaluation for the relevant validation input dataset falls below a second threshold value specified by a second threshold, wherein the at least one signal time series of the validation input dataset is enlarged by a predetermined number of elements, wherein the sensor model is configured as an input neuron layer having a number of additional neurons, such that the input neuron layer has a number of elements corresponding to the number of elements of the validation input dataset, wherein the second model evaluation occurs by shifting the model parameters of the neurons in the input neuron layer.

It can be provided that the distance is determined using an L2 standard, L-infinity standard, or as a difference between the change-point times represented by the model outputs.

According to a further aspect, an apparatus for carrying out the above method is provided.

### BRIEF DESCRIPTION OF THE DRAWINGS

Embodiments are described in further detail below with reference to the accompanying drawings. The figures show:

FIG. 1 a sensor system for determining a change-point time in an evaluation time window;

FIG. 2 a schematic view of a neural network with neurons;

FIG. 3 a schematic view of the design for determining a robustness of a trained, data-based classification model;

FIG. 4 a flow chart illustrating a method for determining the robustness of the classification model;

FIG. 5 an illustrative view of the shift of the evaluation time window of the signal time series; and

FIG. 6 a schematic view of a sensor model configured as a neural network with additional neurons in the input neuron layer for implementing a model evaluation with a displacement of the input dataset.

### DETAILED DESCRIPTION

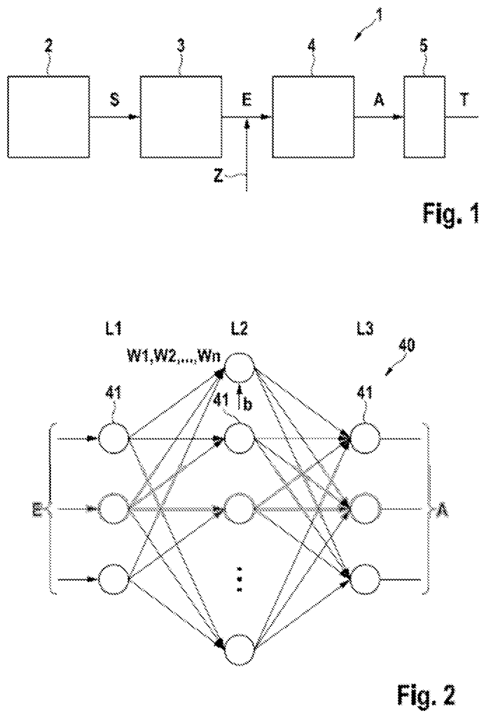

FIG. 1 schematically shows a technical system 1 in the form of a sensor system having a sensor 2 that is configured in order to detect and record continuous measurement signals of the technical system 1. For example, the sensor 2 can correspond to a pressure sensor, a mass flow sensor, a temperature sensor, an acceleration sensor, a vibration sensor, a radiation sensor, a camera system, a radar or LiDAR system, or the like and can provide sensor data S in a suitable manner. The sensor data S are sampled in a sampling block 3 so that sampled sensor data E are provided.

Furthermore, one or more state variables Z of the technical system 1 that characterize a state of the technical system 1 can additionally be sensed and provided. The sampled sensor data S and the one or more state variables Z form the elements of an input dataset E for a data-based sensor model 4. For this purpose, the input data dataset E is available directly or in a standardized manner for further processing on the data-based sensor model 4.

The sensor model 4 can be configured in the form of a data-based model configured as a regression or classification model. The data-based sensor model 4 can correspond to a deep neural network having multiple layers of functionally coupled neurons, in a manner known per se. Alternatively, the sensor model 4 can also be configured with a recurrent neural network, a convolutional neural network, or other data-based model. The sensor model 4 can comprise a function that provides further processing of the sensor data, a control dependent on the sensor data, a determination of a technical quantity dependent on the sensor data, or the like.

At the output of the sensor model 4, as a function of the input dataset E, an output vector A=m(E) is provided from the sensor data S and the one or more state variables Z as an evaluation result, which includes a desired datum extracted from the input dataset E as a regression one or more regression values or as a classification one or more class assignments.

FIG. 2 schematically shows the construction of a deep neural network 40 as an example for an evaluation model 4 with multiple layers L, which in the embodiment example shown correspond to an input layer L1, an inner layer L2 and an output layer L3, each with several neurons 41.

Each neuron 41 performs a neuron function on supplied input values from each neuron of the previous layer or the input vector E, respectively. The neuron function includes a sum formation of inputs weighted according to weights W1, W2, . . . , Wn of a weighting vector W, and a bias value b representing model parameters of the sensor model 4. The weightings are provided by a weighting matrix W for the respective layer L2, L3, and the bias value b is provided by a bias vector b specified for the respective layer. The sum value is further supplied to a non-linear activation function, for example, which may correspond to a ReLU function.

Thus, in the training of the neural network, the model parameters in the form of a weighting matrix W and a bias vector b are determined for each of the layers L1, L2, L3 of the neural network.

To train the sensor model, training datasets can first be provided from input datasets and corresponding associated labels. Alternatively, the sensor model can also be trained with unlabeled training data. The input dataset can comprise one or more signal time series of elements, which can each include temporally successive values of, for example, a sensor signal, corresponding to a sampling rate. Additionally, the input dataset can comprise one or more state variables. The training datasets assign a label to such an input dataset that is configured as a sensor model in the form of a classification vector in a classification model. The classification vector indicates the change-point time.

This classification vector typically features dimensionality, with a number of elements each being associated with a class, wherein each class is associated with a given point in time or time portion within the evaluation window which is covered by the sensor signal time series. The argmax of the classification vector corresponds to the classification to be determined, i.e., the index value of the relevant element in the classification vector corresponds to a certain, previously specified time within the evaluation window covered by the signal time series. The classification model can thus be designed to indicate the change-point time in the form of a classification vector, wherein the change-point time is indicated as argmax of the classification vector. This classification vector can be determined in an evaluation block 5 corresponding to the argmax function and a mapping function for mapping the time point to be determined in the above-mentioned manner in order to obtain a change-point time T as the model output.

The label of the classification vector consists of a vector which comprises a change-point point in time in the form of a first value of, for example, one of the elements which corresponds to the time point or time portion of the change-point time, while assigning a second value of, for example, 0 to the remaining elements.

The robustness of such a trained, data-based sensor model 4 can now be determined using unlabeled input datasets.

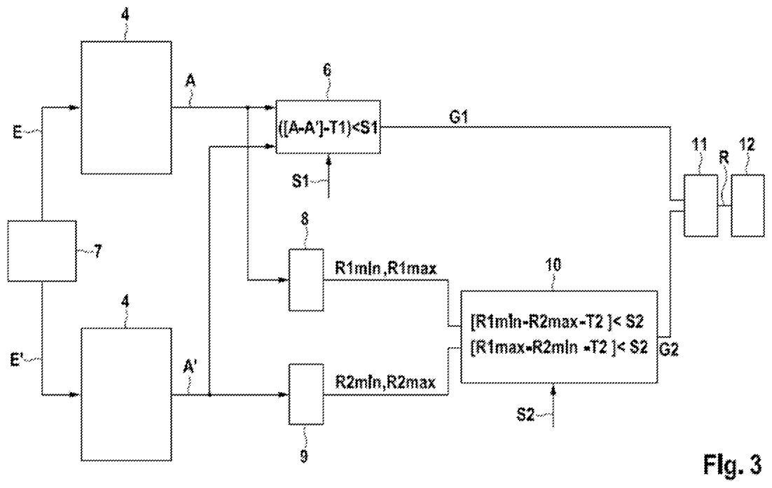

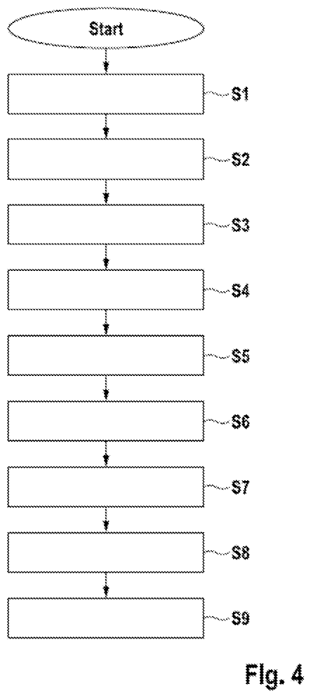

In conjunction with the block diagram of FIG. 3 and the flow diagram of FIG. 4, a method for determining the robustness of the data-based sensor model 4 previously trained and, if necessary, implemented in the technical system 1 will now be described.

In step S1, unlabeled validation input datasets E are provided, the format of which corresponds to the format of the input datasets of the training data. The validation input datasets E include at least one signal time series of a sampled sensor signal in an evaluation time window.

A degree of robustness R is now evaluated. For this purpose, model outputs m(E)=A of the validation input datasets E are determined in step S2.

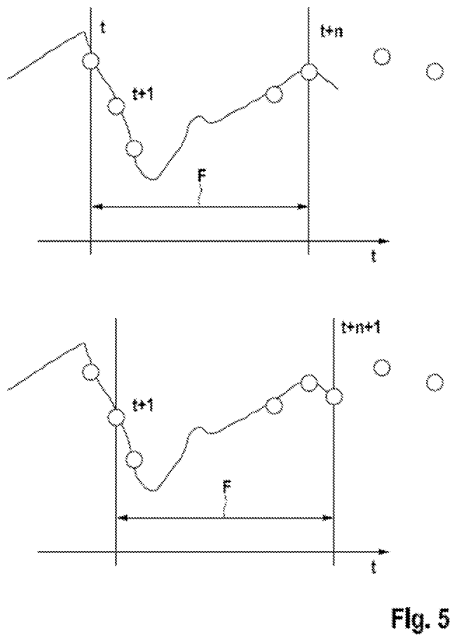

In step S3, model outputs m(E′)=A′ for modified validation input datasets E′ are determined. In the modified validation input datasets, for each validation input dataset, the elements of the at least one signal time series are shifted by a predetermined number of digits using a shifting block 7, preferably by a location, in particular by a left or right shift and a corresponding evaluation using the sensor model 4. In FIG. 5, by way of example, the creation of the modified validation input datasets is illustrated by sliding the evaluation time window F over the sampled sensor signal.

By shifting the signal time series by a specified number of digits, it is assumed for an ideal sensor model that the change-point time, which is obtained from the output vector, shifts in a corresponding manner by an offset time duration corresponding to the predetermined number of digits. For this period of time, the model-based determined change-point time is expected to be spaced apart from the previously determined change-point time of the unchanged signal time series.

In step S4, in a first validity block 6, all validation input datasets E—for which a distance between the respective model outputs m(E) for the validation input datasets E and the model outputs m(E′) of the modified validation input datasets E′, taking into account the temporal shift of the offset time duration over a specified first threshold value S1 expected due to the modification, results for a pre-determined distance metric (L2 standard, L-infinity standard, etc.)—are defined as being non-robust, which can be indicated by a first robustness value G1. With an offset duration of T1, it can be checked whether for a robust function

abs(m(E′)−m(E)−T1)<=S1

must apply.

Now, in step S5, a second robustness value G2 is subsequently determined for all validation input datasets not previously detected as non-robust. A maximum and minimum first robustness value, R1min, R1max, in a first robustness block 8, is determined for each validation input dataset determined to be non-robust, which represent the limits of the model output for the validation input dataset to be examined when the validation input dataset in question is varied within a specified epsilon environment. For the robust bounds of a single network, a known method can be used, as described by Jang, Kolter, Schmidt, “Scaling provable adversarial defenses,” https://arxiv.org/abs/1805.12514. The epsilon environment indicates a distance measure (corresponding to a specified distance metric) within which the validation input datasets for determining the second robustness value G2 are varied.

In step S6, for each validation input dataset E determined to be non-robust, a validation input dataset E′ modified in the manner described above is determined. Further, for the modified validation input dataset E′, a second maximum and minimum robustness value R2 min, R2max is determined in a second robustness block 9, which indicate the limits of the model outputs for each of the modified validation input datasets E′ when the respective validation input dataset E is randomly varied within a specified epsilon environment.

In step S7, in a review block 10, for each of the validation input datasets E, it is checked whether a distance/difference between the minimum robustness value R1min of the relevant validation input dataset and the maximum robustness value R2max of the relevant modified validation input dataset E′ (maximum distance/deviation between two robustness values) minus the offset time duration S2T2 exceeds a second threshold value. If so, the relevant validation input dataset E is marked as non-robust, which can be indicated by a second robustness value G2. Analogously, for a robust input dataset:

abs(R1 min−R2max−T2)<S2.

In step S8, for each of the validation input datasets in the checking block 10, it is checked whether a distance/difference between the maximum robustness value R1max of the relevant validation input dataset E and the minimum robustness value R1min of the relevant modified validation input dataset E minus the offset time duration T2 exceeds the specified second threshold. If so, the relevant validation input dataset E is marked as non-robust, which can be indicated by the second robustness value G2. Analogously, for a robust input dataset:

abs(R1max−R2 min−T2)<S2.

In step S9, a robustness measure block 12 provides a degree of robustness R of the trained, data-based sensor model that results from the proportion of validation input datasets E remaining as a robustness value, i.e. the validation input dataset E, for which the first robustness value G1 and the second robustness value G2 indicates that the respective validation input dataset E is robust with respect to the total number. The AND linkage of the robustness values G1, G2 is performed in an AND block 11.

Depending on the degree of robustness R, a retraining of the data-based sensor model can be carried out.

For the retraining, the non-robust validation input datasets are evaluated by determining a smallest epsilon (mineps, from 0 . . . ∞) of the epsilon environment for which the respective validation input dataset is not robust, e.g. zero if the respective validation input dataset is not correctly classified, even without robustness.

This smallest epsilon mineps for each non-robust validation input dataset can be normalized to be in the interval [0, 1], preferably by weight g=e\hat{ }−mineps. Then, g is in [0.1]. A higher weight means less robust. In post-training, this weight can be used to weigh less robust validation input datasets more heavily, whether in a cost role or in that the weight indicates the frequency for which the validation input dataset E is used in the post-training of the system model. The weight g can also indicate an uncertainty at the data point of the validation input dataset E.

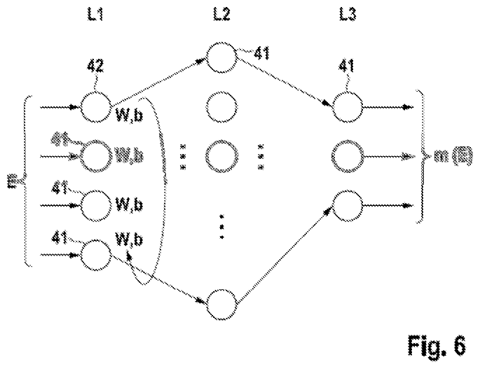

The shifting of the signal time series can be performed as described above according to the above method by shifting the signal time series left or right by one or more digits. Alternatively, as shown schematically in FIG. 6, the determination of the second robustness value can be made using a modified sensor model 4. To this end, a signal time series extended by one or more elements can be provided in the validation input datasets. The previously trained sensor model 4 is configured as a neural network.

To determine the first and second minimum and maximum robustness values R1min, R1max, R2 min, R2max for further evaluation as described above, the sensor model 4 is modified so that the input neuron layer comprises one or more additional neurons with respect to the originally trained sensor model 4. The number of additional neurons corresponds to the number of shifts of the signal time series in the respective validation input datasets or the number of elements provided in order to modify the validation input datasets by which the signal time series is extended.

The supplied validation input datasets are now evaluated with 4 in duplicate. The input dataset E is evaluated on the input side as described above. The additional neurons of the input neuron layer L1 have weights of 0 so that they are passive and do not affect the model output.

The second evaluation is now carried out by shifting the weightings and biases of the neurons of the input layer to the previously passive neurons, so that a new assignment of each element of the input dataset to the associated neuron 41 of the input neuron layer L1 can be achieved without changing the provided input dataset. The weightings of the neurons that become free due to the shifting of the weights and bias values are set to zero.

By shifting the weighting vectors and bias values along the neurons in the input neuron layer and filling in the freed neurons with 0 as model parameters, the evaluation of shifted signal time series can be easily implemented.

What is claimed is:

1. A computer-implemented method for determining a degree of robustness for a robustness of a provided, trained, data-based sensor model for evaluating an input dataset having at least one signal time series in order to determine a model output representing a change-point time, the method comprising:
providing a plurality of unlabeled validation input datasets to the sensor model;
determining a plurality of robust validation input datasets of the plurality of unlabeled validation input datasets that satisfy a first robustness criterion and/or a second robustness criterion; and
determining a proportion of the plurality of robust validation input datasets out of the plurality of unlabeled validation input datasets in order to obtain the degree of robustness.

2. The method according to claim 1, wherein:
the first robustness criterion indicates that a corresponding unlabeled validation input dataset is robust when a distance between a first model output of the sensor model for the corresponding unlabeled validation input dataset and a second model output of the sensor model for a modified validation input dataset falls below a first threshold value specified by a first threshold, and
the modified validation input dataset corresponds to a temporal shift of the signal time series in the validation input dataset through an element-wise shift.

3. The method according to claim 2, wherein:
the second robustness criterion indicates that a corresponding unlabeled validation input dataset is robust when a maximum distance between a minimum threshold value or maximum threshold value of the first model output and a minimum threshold value or maximum threshold value of the second model output falls below a second threshold value specified by a second threshold, and
the minimum or maximum threshold value results from a distribution of model outputs from a specified epsilon environment of the corresponding unlabeled validation input dataset and the modified validation input dataset by sampling from the epsilon environment of the corresponding unlabeled validation input dataset or the modified validation input.

4. The method according to claim 2, wherein the first threshold value and the second threshold value, respectively, consider or depend on the temporal shift of the signal time series of the corresponding unlabeled validation input dataset for creating the modified validation input dataset.

5. The method according to claim 1, wherein:
the trained sensor model includes a deep neural network comprising multiple neuron layers with neurons that are calibrated using model parameters, and
the second robustness criterion indicates that a corresponding unlabeled validation input dataset is robust when a maximum distance between a minimum threshold value or maximum threshold value of a first model output of a first model evaluation for the corresponding unlabeled validation input dataset and a minimum threshold value or the maximum threshold value of a second model evaluation for the relevant validation input dataset falls below a second threshold value specified by a second threshold, and
the at least one signal time series of the validation input dataset is enlarged by a predetermined number of elements,
the sensor model is configured as an input neuron layer having a number of additional neurons, such that the input neuron layer has a number of elements corresponding to the number of elements of the corresponding unlabeled validation input dataset, and
the second model evaluation occurs by shifting the model parameters of the neurons in the input neuron layer.

6. The method according to claim 2, wherein the distance is determined using an L2 standard, L-infinity standard, or as a difference between the corresponding change-point times represented by the model outputs.

7. The method according to claim 1, wherein an apparatus is configured to carry out the method.

8. The method according to claim 1, wherein a computer program product comprises instructions which, when the computer program product is executed by a computer, prompt the computer to perform the method.

9. The method according to claim 1, wherein a non-transitory machine-readable storage medium comprises instructions that, when executed by a computer, prompt the computer to carry out the method.
